(19) United States
(12) Patent Application Publication
(10) Pub. No.: US 2015/0206236 A1
(43) Pub. Date: Jul. 23, 2015

(54) Multiple-node supply chain price determination via mobile phone text message

(71) Applicant: International Business Machines Corporation, Armonk, NY (US)

(72) Inventors: Frank Richard Bauerle, Arlington, TX (US); Grant Douglas Miller, Arvada, CO (US); Nader M. Nassar, Yorktown Heights, NY (US); Tamer M. Nassar, Bethel, CT (US); Irene Robin Penney, Fishkill, NY (US)

(73) Assignee: International Business Machines Corporation, Armonk, NY (US)

(21) Appl. No.: 14/159,446

(22) Filed: Jan. 21, 2014

(51) Int. Cl. G06Q 40/04; H04W 4/14

(52) U.S. Cl. CPC G06Q 40/04; H04W 4/14

(57) ABSTRACT

In a hierarchical multiple-node supply chain, a commodity is sold a first time at a first end of the supply chain and is resold multiple times across the supply chain before being sold a final time at a second end of the supply chain opposite the first end. A user who is a buyer and/or a seller within the supply chain is interacted with by exchanging text messages with a mobile phone device of the user to provide the user with a current price of the commodity for a type of the user within the supply chain, and to receive from the user an actual price of the commodity in a current transaction in which the user was involved. The type of the user includes a node within the supply chain to which the user corresponds.

### BACKGROUND

Developing countries are typically those in which the citizens have lower per-capita incomes than more developed countries. Nevertheless, many developing countries still have vibrant, albeit more locally oriented economies. Another difference between the economies of developing countries and the economies of more developed countries is that the former may not have as sophisticated infrastructure readily available to the economy's participants as compared to the latter.

### SUMMARY

An example method includes interacting with a user who is one or more of a buyer and a seller within a hierarchical multiple-node supply chain in which a commodity is sold a first time at a first end of the supply chain and is resold multiple times across the supply chain before being sold a final time at a second end of the supply chain opposite the first end. This interaction includes receiving a first text message from a mobile phone device of the user, by a computing device, the first text message requesting a current price of the commodity for a type of the user within the supply chain. The interaction includes determining, by the computing device, the type of the user within the supply chain including a node within the supply chain to which the user corresponds, and determining, by the computing device, the current price of the commodity for the type of the user within the supply chain. The interaction includes sending a second text message to the mobile phone device of the user, by the computing device, the second text message returning the current price of the commodity for the type of the user within the supply chain.

An example computer program product includes a storage device storing computer-executable code executed by a computing device to perform a method. The method includes interacting with a user who is one or more of a buyer and a seller within a hierarchical multiple-node supply chain in which a commodity is sold a first time at a first end of the supply chain and is resold multiple times across the supply chain before being sold a final time at a second end of the supply chain opposite the first end. This interaction includes exchanging text messages with a mobile phone device of the user to provide the user with a current price of the commodity for a type of the user within the supply chain including a node within the supply chain to which the user corresponds, and to receive from the user an actual price of the commodity in a current transaction in which the user was involved.

An example system includes a database of actual prices realized for a commodity in transactions within a hierarchical multiple-node supply chain in which the commodity is sold a first time at a first end of the supply chain and is resold multiple times across the supply chain before being sold a final time at a second end of the supply chain opposite the first end. The system includes communication hardware to communicatively connect with a user who is one or more of a buyer and a seller within the hierarchical multiple-node supply chain. The system includes a processor, and a storage device storing a computer program executable by the processor. The system includes a first module implemented by the computer program to interact with the user by exchanging text messages with a mobile phone device of the user to provide the user with a current price of the commodity for a type of the user within the supply chain including a node within the supply chain to which the user corresponds.

### BRIEF DESCRIPTION OF THE SEVERAL VIEWS OF THE DRAWINGS

The drawings referenced herein form a part of the specification. Features shown in the drawing illustrate only some embodiments of the disclosure, and not of all embodiments of the disclosure, unless the detailed description explicitly indicates otherwise, and readers of the specification should not make implications to the contrary.

FIG. 1 is a diagram of an example hierarchical multiple-node supply chain.

FIG. 2 is a flowchart of an example method performed by a system to interact with users of a hierarchical multiple-node supply chain via text message to provide current prices and to receive actual prices.

FIGS. 3A and 3B are flowcharts of two example methods performed by a system to determine the current price of a commodity at a given node of a hierarchical multiple-node supply chain.

FIG. 4 is a diagram of an example environment in which the methods of FIGS. 2, 3A, and 3B can be performed by an example system with respect to a hierarchical multiple-node supply chain via text messages with users.

### DETAILED DESCRIPTION

The following detailed description of exemplary embodiments of the disclosure refers to the accompanying drawings that form a part of the description. The drawings illustrate specific exemplary embodiments in which the disclosure may be practiced. The detailed description, including the drawings, describes these embodiments in sufficient detail to enable those skilled in the art to practice the disclosure. Those skilled in the art may further utilize other embodiments of the disclosure, and make logical, mechanical, and other changes without departing from the spirit or scope of the disclosure.

As noted in the background section, developing countries can have vibrant economies, but often lack the economic infrastructure of more developed countries. For example, in a developed country, a buyer or a seller within a supply chain generally has a wealth of pricing information available to him or her. By comparison, in a developing country, a comparable buyer or seller within a supply chain may not have as readily available such pricing information.

This shortfall of information can be for a variety of different reasons. First, such information may not be regularly collected like pricing information is in more developed countries. Second, even if such information is collected, supply chain participants may not have an easy way to obtain the information as needed. For example, while most developed country supply chain participants have access to the Internet at which such information is typically accessible, many of their counterparts in developing countries do not. While mobile communication devices like mobile phones are widespread in developing countries, they are generally of the “basic phone” variety and usually have limited or more often no Internet connectivity.

Techniques disclosed herein overcome these shortcomings. A hierarchical multiple-node supply chain is one in which a commodity is sold a first time at a first end of the supply chain and is resold multiple times across the supply chain before being sold a final time at a second end of the supply chain opposite the first end. A user is a buyer and/or a seller within this supply chain. A text message is received from the user's mobile phone device, requesting a current price of the commodity for the type of the user within the supply chain. The type of this user is determined, as is the current price of the commodity for this user type. A text message is sent back to the user's mobile phone device in which the current price of the commodity for the user's type is provided. Once the user has completed a transaction as a buyer or as a seller, he or she may then send a text message indicating the actual price of the commodity that was realized, and this actual price stored.

As such, the techniques disclosed herein overcome the two notable shortfalls described above. First, pricing information within the supply chain is collected from transaction participants, and is used to provide pricing information when these or other buyers and sellers request this information. Therefore, pricing information within the supply chain is both aggregated and disseminated. Second, all interaction with the supply chain participants is conducted using text messages. Even if the participants only have lower technology mobile phones that do not have Internet connectivity, nearly every mobile phone has the ability to send and receive text messages, thus permitting usage of the techniques disclosed herein to nearly all those who participate in the supply chain.

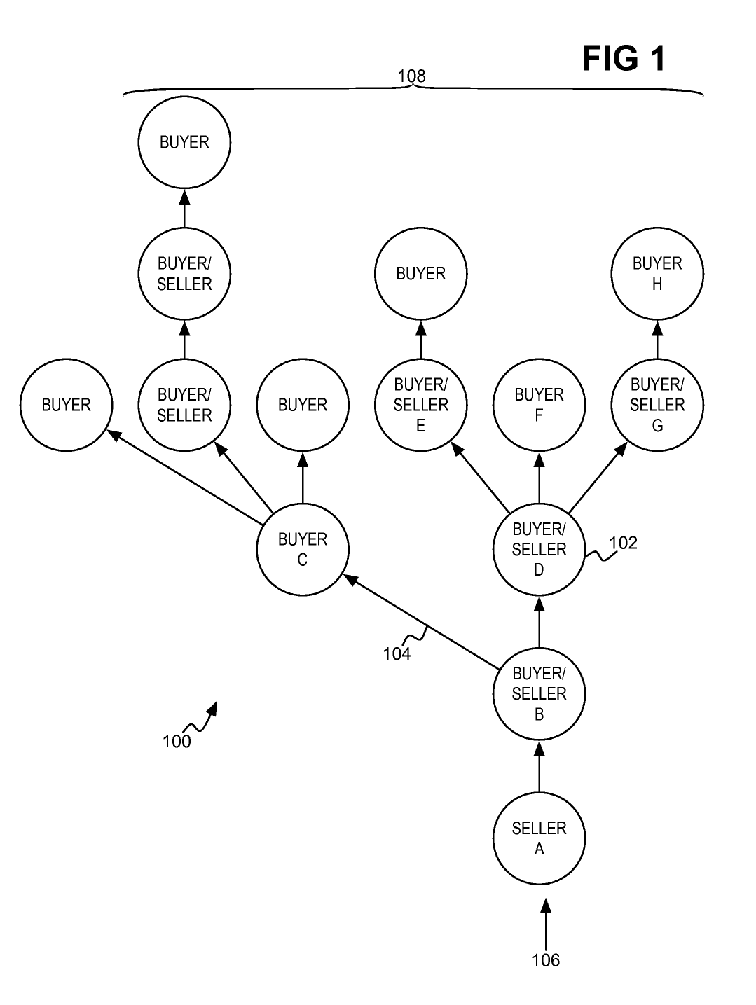

FIG. 1 shows an example hierarchical multiple-node supply chain 100. The supply chain 100 includes nodes 102 separated by edges 104. Each node 102 corresponds to a type of buyer, seller, or buyer/seller within the supply chain 100. Each edge 104 is also referred to as a node hop, and corresponds to a transaction in which a commodity, like livestock, agricultural goods, and so on, occurs between a seller of the node 102 from which the edge 104 is directed to a buyer of the node 102 to which the edge 104 is directed. The supply chain 100 starts at a first end 106 at which a commodity is sold the first time, and ends at a second end 108 at which the commodity is sold the last time.

Participants within the supply chain 100—i.e., users that are each a buyer and/or a seller—can correspond to different nodes 102 at different times. For instance, depending on the current transaction in which a user is participating within the supply chain 100, the user can correspond to a different node 102. The type of the user to which each node 102 can be based on at least two factors. The first factor can be the level of the node 102 within the hierarchy of the supply chain 100, in terms of the distance of the node 102, by node hops, from the first end 106 or the second end 108 of the supply chain 100. The second factor can be the physical geographic location of users of this type. Therefore, some node hops may correspond to shorter geographical distances than other node hops do.

As an example of traversing the supply chain 100, consider a seller A who is a farmer selling a goat. Within the supply chain 100, there is just one type of user, who is buyer/seller B, who can purchase the goat from seller A. For example, the seller A may be the type of user in a local village that has readily accessible to him or her just one local market at which goats are the subject of transactions. The buyer/seller B in turn has two types of users who can purchase the goat from the buyer/seller B, which are the buyer/seller C and the buyer/seller D. For example, the buyer/seller B may be the type of user who is able to transport the goat from the local market to one of two regional markets, which may be at different distances from the local market.

Assume the buyer/seller B sells the goat to the buyer/seller D at one of these regional markets. The buyer/seller D has three types of users who can purchase the goat from buyer/seller D, which are the buyer/seller E, the buyer F, and the buyer/seller G. The buyer F may correspond to a user at a slaughterhouse that processes goat meat, such that once the buyer F purchases the goat, the goat is effectively taken out of the supply chain 100. The buyer/seller E and the buyer/seller G may correspond to users at different regional markets. Note in this respect that one of these markets may even be the same regional market as that in which the buyer/seller C participates, but is represented as a separate node 102 within the supply chain 100 because it is one node hop further removed from the seller A.

Assume that the buyer/seller D sells the goat to the buyer/seller G at a regional market to which users of the type of the buyer/seller G corresponds. The buyer/seller G may be the type of user that has available to him or her just one type of user, the buyer H, who may be a user at a slaughterhouse that processes goat meat, such that once the buyer H purchase the goat, the goat is taken out of the supply chain 100. Note in this respect that the buyer H may even correspond to users at the same slaughterhouse as the buyer F does, but is represented by a different node 102 within the supply chain 100 because it is one node hop further removed from the seller A.

Traversals of commodities within the hierarchical supply chain 100 thus proceed from the first end 106 to the second end 108. Once a commodity has moved a particular hop farther away level-wise from the first end 106, the directed edges 104 are such that the commodity cannot then move closer back level-wise to the first end 106. One reason this is the case is because different nodes 102 can represent users of the same type—such as users in the same regional market—but at different numbers of hops away from the seller A in a given traversal of the supply chain 100, as noted above. Stated another way, the hierarchical supply chain 100 is represented in the example of FIG. 1 as a tree, which is a particularly type of directed acyclic graph.

However, in other implementations, the supply chain 100 may be represented by different types of multiple-node graphs. For instance, the supply chain 100 may be a directed acyclic graph, but one that is not a tree. As one example of this, there may be multiple nodes at the first end 106 as well as multiple nodes at the second end 108, as compare to just multiple nodes at the second end 108 as in FIG. 1.

Furthermore, the supply chain 100 is such that the second end 108 at which a commodity is sold the final time can be differing numbers of hops away from the seller A at the first end 106, depending on the particular path that a given commodity instance takes through the supply chain 100. For example, a traversal from seller A, to buyer/seller B, to buyer/seller D, to buyer F represents three node hops to reach the second end 108. By comparison, a traversal from seller A, to buyer/seller B, to buyer/seller D, to buyer/seller G, to buyer H represents four node hops to reach the second end 108.

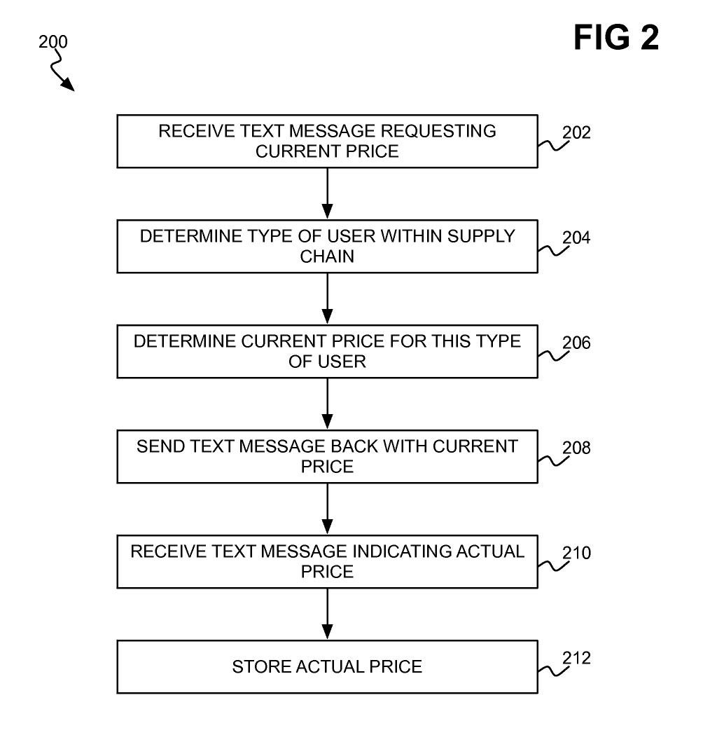

FIG. 2 shows an example method 200 performed by a computing system in relation to a hierarchical multiple-node supply chain, such as the supply chain 100. An example of such a system is described later in the detailed description. In general, the method 200 is for interacting with users who are buyers and/or sellers within the supply chain. The method 200 is thus performed for each user, responsive to a user wishing to interact with the system. In this respect, it is noted that not all participants with a supply chain have to interact with the computing system via the method 200. Participants generally are incented to interact, however, because they can receive pricing information for commodities, and by providing actual prices of transactions involving these commodities, can ensure the accuracy of this information.

A text message is received from the mobile phone device of a user (202). This text message is a request from the user to request a current price of a commodity for a type of the user within the supply chain. It is noted that the request may be particularly formatted in a way in which the computing system expects requests to be received. However, some users within the supply chain may not be particularly adept at technology in this respect, and therefore the system may be more robust, by employing natural language and other techniques to parse the text message and decipher that the user is requesting the current price of a commodity.

The type of the user within the supply chain—that is, the node within the supply chain to which the user corresponds—is determined (204). This determination can be achieved in multiple ways. For instance, the location of the user may be mapped to a particular node, especially if the nodes map to the locations on a one-to-one basis, which is somewhat different than in the supply chain 100 described above, where some nodes may map to locations on a many-to-one basis.

For nodes that map to the locations on a potentially many-to-one basis, as in the supply chain 100, as well as more generally, other information may also be employed to determine the node to which the user corresponds. Whether the user has been a buyer or a seller historically at the location in question may assist in this determination, for instance. The identity of the user may be determined by the user's mobile phone number from which the text message was sent. Other historical information that may potentially be available, including the user's prior transactions and with whom, can be used to assist determination of the node to which the user corresponds.

However, the number of nodes that map on a many-to-one basis to locations is likely to be low, such that node determination in part 204 is likely to be incorrect infrequently. Furthermore, even if this determination is incorrect, sellers, for instance, at a particular regional market are likely to be able to around the same price for a commodity regardless of the number of hops from the starting end of the supply chain. This is because buyers may generally not care about this distinction when making purchases.

Further, even if the node to which the user corresponds is not correctly determined, in a many-to-one relation of nodes to locations, the system may provide a feedback mechanism by which the user can indicate that the pricing information he ultimately receives is likely wrong, which the system can interpret as an incorrect node determination. For instance, if a seller at a node hop farther away from the starting end of the supply chain is indeed likely to get a higher price than a seller at the same location but at a node hop closer to the starting end of the supply chain, then a user is mistaken as corresponding a node corresponding to the latter type of seller instead of to the former is likely to realize that the price received back is too low. The user may send back a text message indicating that the price is wrong, and the system may correspondingly take this to mean that it had determined the wrong node, and start again.

Once the type of the user within the supply chain has been determined, then the current price for this user type within the supply chain is determined (206). Different approaches for determining the current price are described in detail later in the detailed description. In general, however, each node hop from the starting node typically corresponds to an increase in price realized in sale or in purchase of the commodity. This is because each node hop means that another transaction in which the commodity is sold from a seller to a buyer (who may then become the seller in the next transaction) has occurred, such that the price correspondingly increases.

The pricing can increase owing to a variety of different factors. For instance, the longer the distance in traversing a node hop likely means a larger price increase, because transportation costs are higher. The type of commodity, and the difficulty in performing the node hop in question, also dictate this price increase. Another factor is risk regarding where in the supply chain the current transaction currently is. A seller towards the first end of the supply chain has more risk as to whether the commodity will still be needed as it winds its way through the supply chain as compared to a seller towards the second end of the supply chain, and thus ask for an commensurately larger increase in price.

More macro factors can also affect pricing. For instance, the current political stability of the country in which the transaction is occurring, the current weather, and even the time of year can affect pricing. For example, for an agricultural commodity, weather can dictate crop outlook, and so on. As for time of year, a commodity may be more in demand at some times of year than at other times of year.

Another factor that affects pricing is the expected profit margin of the seller, which itself relies on at least some of the other factors noted above. For instance, a seller may expect to realize a net profit margin of a predetermined percentage. However, this margin may be decrease where competition is high and/or when a large supply of the commodity in question is available. The margin may increase when competition is low or the commodity is scarce, similarly.

Furthermore, pricing can at times decrease across node hops. This may be because a commodity has a certain life expectancy. A goat, for instance, may be more valuable when alive than when it is not. If a particular goat is nearing the end of its life, then a seller may ask for less of a price than what he or she paid for it, just to ensure that the seller gets at least a portion of what he or she has put into the commodity. Similarly, if a goat becomes sick as it traverses the supply chain, the user who currently has the goat when it becomes sick is likely to not be able to receive as high a price as when before the goat became sick.

Once the current price of the commodity has been determined, the user that had requested the price is sent a text message back to his or her mobile phone device that includes the current price for the type of the user within the supply chain (208). The user can then use this information to ask for a particular price for a commodity that the user is either selling or buying. The user thus sends the request in part 202 prior to engaging in negotiation, and begins negotiation after having received the response in part 208. The current price received is not a “done deal” price for the commodity, but rather is information that can guide the user in ensuring that a fair price is offered or received for the commodity that is the subject of the transaction in which the user is currently participating.

It is noted that the current price that is determined and sent to the user is desirably the optimal price, using the information available to determine this price. The price is desirably optimal in that it will be agreeable to both the buyer and the seller. In this way, the amount of negotiation that has to occur prior to completion of the transaction may be reduced, for time and other savings. That is, the optimal price may be a better starting point at which negotiation is to occur—and indeed, in the best-case scenario, the optimal price will be immediately accepted by both parties, without any negotiation whatsoever.

Once the user has successfully completed a transaction, the system can receive a text message from the user's mobile phone device indicating that actual price that the user realized in the current transaction for the commodity (210). The actual price can vary from the current price that the system had provided to the user. The more often the system receives actual transaction prices for a commodity from users via their mobile phone devices, however, the more accurate the current prices that the system sends to users are likely to be in relation to the actual transaction prices. Therefore, users have an incentive to report the actual transaction prices realized, which are then stored by the system (212) to reference when subsequently determining the current price of the commodity again.

In this respect, it is noted that a particular user within the supply chain does not have to fully—or even at all—participate in the process outlined by the method 200. Some users may not participate at all. Some users may both request current prices of commodities and report back the actual prices they received in completed transactions. Some users may just request current prices but not report back actual prices, and some users may just report actual prices but not request current prices. In likelihood, it is expected that at a given buyer or seller is likely to flit among these various scenarios, where at some times the user is diligent about reporting actual prices, but at other times is not, and at some times requests current prices, but at other times does not.

As noted above the current price of a commodity for a type of user (i.e., for a given node of the supply chain), can be determined in a number of different ways. One way is to simply set the current price to the price at which the commodity has recently sold at this node, by referencing a database in which the actual prices are stored. The most recent price may be used, an average of the most recent prices less than a certain number of days old may be used, or a weighting of price based on recency may be used in this respect.

Another way is to set the current price to the price at which the commodity has recently sold at nodes (including the given node) at the same hierarchical level as the given node. The hierarchical level in this respect can mean the same number of hops from either the first end or the second end of the supply chain. A price can be determined at each such node, by using one of the methodologies described in the preceding paragraph, and then correspondingly averaged or weighted over all these nodes. A price can be determined by considering the price at any such node, and averaging or otherwise weighting all these prices. Other approaches can also be employed.

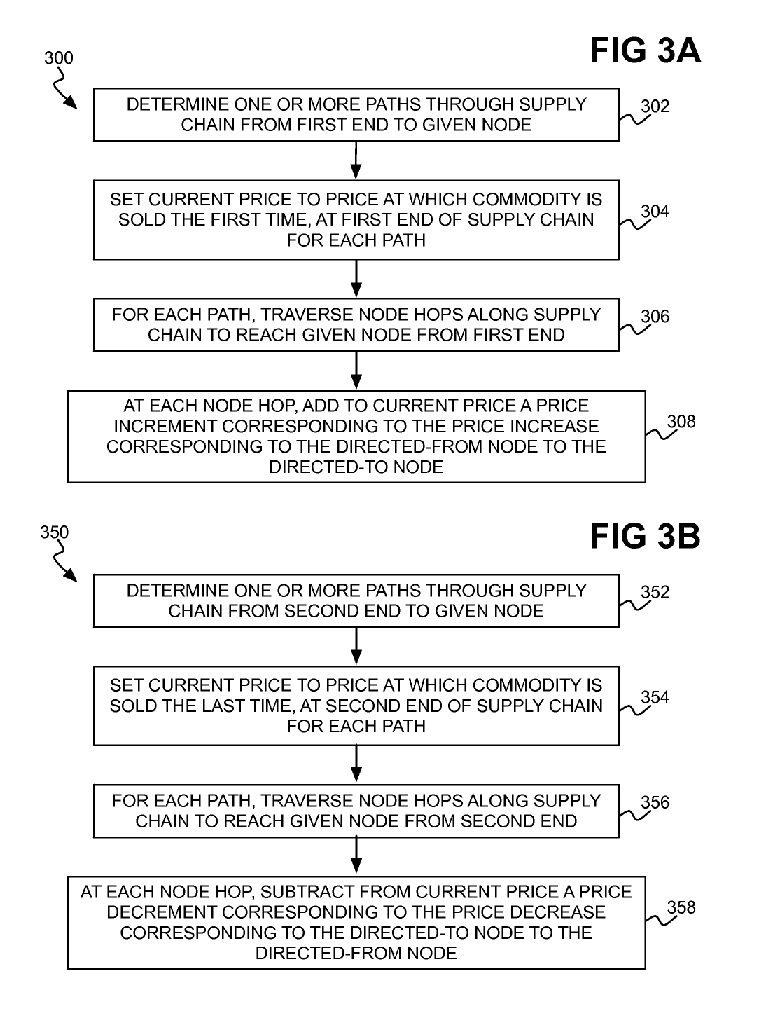

FIGS. 3A and 3B show example methods 300 and 350, respectively, for two other ways by which the current price of a commodity for a type of user corresponding to a given node of the supply chain can be determined. In the method 300, one or more paths through the supply chain are determined from the first end to the given node (302). For the supply chain 100, each such path starts at the same node, since there is just one node at the first end. For each path, the current price is initially set to the actual price at which the commodity has been recently sold the first time at the first end of the supply chain (304), in one of the manners described above. Note that for the supply chain 100, the initial price set in part 304 is the same for each path, since all the paths start at the same node.

For each path, the node hops are traversed along the supply chain to reach the given node from the first end (306). Each node hop corresponds to an edge of the supply chain. As such, each node hop includes a directed-from node from which the edge points and a directed-to node to which the edge points. At each node hop (of each path), the current price for the path including this node hop has added thereto a price increment corresponding to the price increase in the actual price from the directed-from node of the node hop to the directed-to node of the node hop (308). The resulting current prices for the path may then be averaged or otherwise combined to yield the current price of the commodity for the type of user in question.

In the method 350, the reverse approach is taken, starting from the second end and proceeding back to the given node instead of starting from the first end and proceeding to the given node. Specifically, one or more paths through the supply chain are determined from the second end back to the given node (352). For supply chains having more than one node at the second end, therefore, the initial nodes of at least one of these paths will be different. For each path, the current price is initially set to the actual price at which the commodity has been recently sold the last time at the second end of the supply chain (354), in one of the manners described above.

For each path, the node hops are traversed along the supply chain in reverse to reach the given node from the second end (356). Each node hop corresponds to an edge of the supply chain, as before, such that each node hop includes a directed-from node from which the end points and a directed-to node to which the edge points. At each node hop (of each path), the current price for the path including this node hop has subtracted therefrom a price decrement corresponding to the price decrease in the actual price from the directed-to node of the node hop to the directed-from node of the node hop (358). The resulting current prices for the path may then be average or otherwise combined to yield the current price of the commodity for the type of user in question.

Determining the current price using the method 300 or 350 (or both in one implementation, where the current price is then determined by averaging or otherwise combining the two prices determined) is thus more complicated than the other ways to determine the current approach that have been described, but may be more accurate. In particular, determining the current price using the method 300 or 350 leverages more of the price information stored in the database, because the actual prices at more nodes is considered to determine the current price for the given node. If the database stores actual prices (and the times at which they were realized) for a commodity by node, price decrements or increments for node hops can be determined by comparing the actual prices of the two nodes of each node hop.

For instance, the current price at a directed-from node of a node hop may be determined, in one of the ways described above, and the current price at the directed-to node of the node hop may likewise be determined. One of these two current prices is subtracted from the other to yield the price decrement or increment of the node hop. As another example, each possible price decrement or increment may be determined, by unique combinations of directed-to node actual price and directed-from node actual price pairs. The resulting price decrements or increments can then be combined, such as by averaging, to yield the price decrement or increment of the node hop in question.

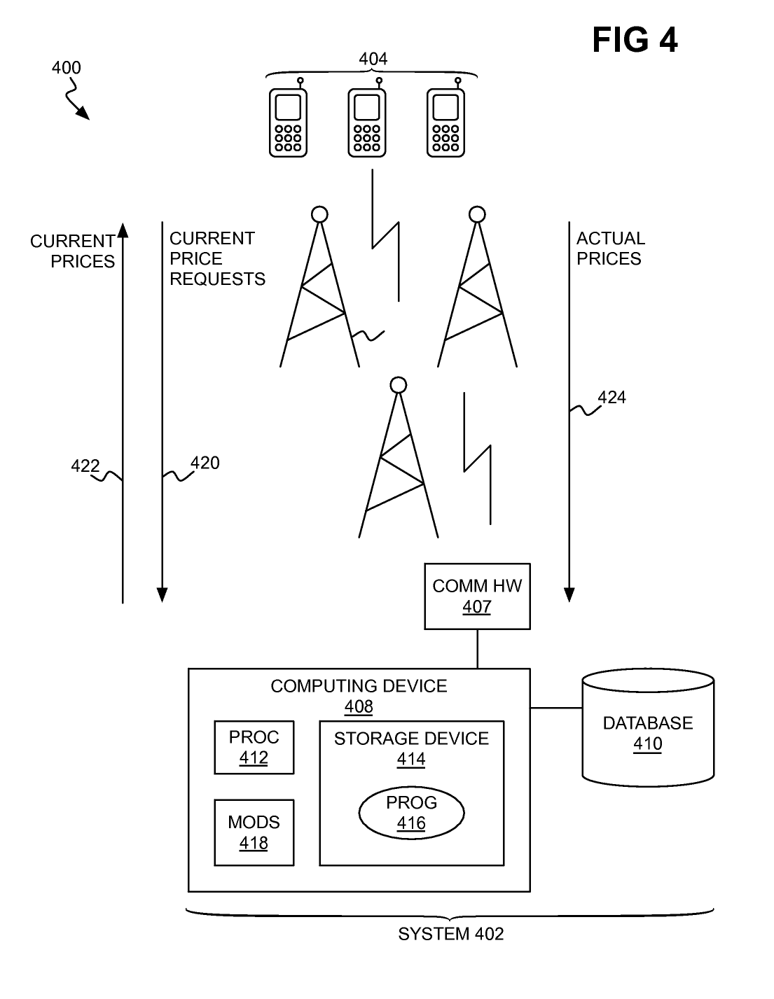

FIG. 4 shows an example environment 400 in which the methods that have been described can be performed by an example system 402. In the environment 400, users with mobile phone devices 404 wirelessly communicate with the system 402 via a number of mobile phone towers 406. For example, communication from a mobile phone device 404 is relayed by one or more of the towers 406 to the system 402, and vice-versa.

The system 402 includes at least communication hardware 407, a computing device 408, and a database 410. The communication hardware 407 is the hardware that permits the system 402 to communicate with the mobile phone devices 404 using text messages, such as via messages sent by short messaging service (SMS), which is also referred to in some global regions as a text messaging service (TMS). A text message may be referred to as simply a text in some global regions, as an SMS in other global regions, and as a TMS in still other global regions.

The database 410 stores actual prices of commodities realized in transactions between buyers and sellers within a supply chain. An actual price is stored as a record within the database 410. A record also includes the node of the supply chain to which the actual price corresponds, the commodity that was the subject of the transaction in which the actual price was realized, and a timestamp when the transaction at which the actual price was realized occurred. Records may be deleted from the database as they become stale. For instance, for a given node, just a predetermined number of records may be stored in the database 410, and when a new record is stored for the node, the oldest record for this node may be deleted. As another example, once records are older than a predetermined length of time, they may be deleted from the database 410.

The computing device 408 may be a server computing device, and in actuality may be or include one or more such computing devices. The computing device 408 includes at least a processor 412 and a storage device 414 storing a computer program 416 (i.e., one or more such computer programs) executable by the processor 412. The computing device 408 includes one or more modules 418 that are said to be realized by the computer program 416 upon execution by the processor 412. The modules 418 cause the computing device 408 to perform the methods that have been described, where the database 410 is utilized in performance of the methods. A first module 418 may be responsible for performing parts 202, 204, 206, and 208 of the method 200 pertaining to providing a user of a mobile phone device 404 a current price at which to start negotiation with respect to a commodity in a transaction. A second module 420 may be responsible for performing parts 210 and 212 of the method 200 pertaining to receiving an actual price realized for a commodity in a transaction from a user of a mobile phone device 404 and correspondingly updating the database 410.

As such, in the environment 400, there are two primary communications that occur between the system 402 and the mobile phone devices 404. In a first communication, a user uses his or her mobile phone device 404 to send a text message request for a current price, as indicated by the arrow 420, and in response the system 402 determines the current price for the node to which the user corresponds and returns it via another text message, as indicated by the arrow 422. In a second communication, a user uses his or her mobile phone device 404 to send a text message to report an actual price realized for a commodity in a transaction, which the system 402 receives.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. (canceled)

2. (canceled)

3. (canceled)

4. (canceled)

5. (canceled)

6. (canceled)

7. (canceled)

8. (canceled)

9. A computer program product comprising a storage device storing computer-executable code executed by a computing device to perform a method comprising:
interacting with a user who is one or more of a buyer and a seller within a hierarchical multiple-node supply chain in which a commodity is sold a first time at a first end of the supply chain and is resold multiple times across the supply chain before being sold a final time at a second end of the supply chain opposite the first end, by exchanging text messages with a mobile phone device of the user to provide the user with a current price of the commodity for a type of the user within the supply chain including a node within the supply chain to which the user corresponds, and to receive from the user an actual price of the commodity in a current transaction in which the user was involved.

10. The computer program product of claim 8, wherein interacting with the user comprises:
receiving a first text message from the mobile phone device of the user, the first text message requesting the current price of the commodity for the type of the user within the supply chain;
determining the type of the user within the supply chain including the node within the supply chain to which the user corresponds;
determining the current price of the commodity for the type of the user within the supply chain; and
sending a second text message to the mobile phone device of the user, the second text message returning the current price of the commodity for the type of the user within the supply chain.

11. The computer program product of claim 10, wherein determining the type of the user within the supply chain comprises:
determining a location of the user; and
determining the node within the supply chain to which the user corresponds from the location of the user.

12. The computer program product of claim 10, wherein determining the current price of the commodity for the type of the user within the supply chain comprises traversing the supply chain from the first end to the node within the supply chain to which the user corresponds, by:
at the first end of the supply chain, setting the current price to a price at which the commodity is sold the first time by referencing a database in which actual prices of the commodity realized in transactions are recorded; and
at each node hop of one or more node hops as the supply chain is being traversed, adding to the current price a price increment corresponding to a node at the node hop, the price increment determined by referencing the database.

13. The computer program product of claim 10, wherein determining the current price of the commodity for the type of the user within the supply chain comprises traversing the supply chain from the second end to the node within the supply chain to which the user corresponds, by:
at the second end of the supply chain, setting the current price to a price at which the commodity is sold the final time by referencing a database in which actual prices of the commodity realized in transactions are recorded; and
at each node hop of one or more node hops as the supply chain is being traversed, subtracting from the current price a price decrement corresponding to a node at the node hop, the price decrement determined by referencing the database.

14. The computer program product of claim 10, wherein determining the current price of the commodity for the type of the user within the supply chain comprises:
setting the current price to a price at which the commodity is sold within the supply chain at one or more of the node to which the user corresponds and a node within the supply chain at a same hierarchical level as the node to which the user corresponds, by referencing a database in which actual prices of the commodity realized in transactions are recorded.

15. The computer program product of claim 8, wherein interacting with the user comprises:
receiving a text message from the mobile phone device of the user, the text message specifying the actual price of the commodity in the current transaction in which the user was involved; and
storing the actual price of the commodity within a database to reference when subsequently determining the current price of the commodity.

16. A system comprising:
a database of actual prices realized for a commodity in transactions within a hierarchical multiple-node supply chain in which the commodity is sold a first time at a first end of the supply chain and is resold multiple times across the supply chain before being sold a final time at a second end of the supply chain opposite the first end;
communication hardware to communicatively connect with a user who is one or more of a buyer and a seller within the hierarchical multiple-node supply chain;
a processor;
a storage device storing a computer program executable by the processor; and
a first module implemented by the computer program to interact with the user by exchanging text messages with a mobile phone device of the user to provide the user with a current price of the commodity for a type of the user within the supply chain including a node within the supply chain to which the user corresponds.

17. The system of claim 16, further comprising a second module implemented by the computer program to receive a text message from the mobile phone device of the user including an actual current price of the commodity in a current transaction in which the user was involved and to store the actual current price within the database.

18. The system of claim 16, wherein first module is to interact with the user interact with the user by:
receiving a first text message from the mobile phone device of the user, the first text message requesting the current price of the commodity for the type of the user within the supply chain;
determining the type of the user within the supply chain including the node within the supply chain to which the user corresponds;
determining the current price of the commodity for the type of the user within the supply chain; and
sending a second text message to the mobile phone device of the user, the second text message returning the current price of the commodity for the type of the user within the supply chain.

19. The system of claim 18, wherein determining the type of the user within the supply chain comprises:
determining a location of the user; and
determining the node within the supply chain to which the user corresponds from the location of the user.

20. The system of claim 18, wherein determining the current price of the commodity for the type of the user within the supply chain comprises one or more of:
performing a first traversal of the supply chain from the first end to the node within the supply chain to which the user corresponds, by:
at the first end of the supply chain, setting the current price to a price at which the commodity is sold the first time by referencing the database;
at each node hop of one or more first node hops as the supply chain is being traversed, adding to the current price a price increment corresponding to a node at the first node hop, the price increment determined by referencing the database;
performing a second traversal of the supply chain from the second end to the node within the supply chain to which the user corresponds, by:
at the second end of the supply chain, setting the current price to a price at which the commodity is sold the final time by referencing the database;
at each node hop of one or more second node hops as the supply chain is being traversed, subtracting from the current price a price decrement corresponding to a node at the second node hop, the price decrement determined by referencing the database; and
setting the current price to a price at which the commodity is sold within the supply chain at one or more of the node to which the user corresponds and a node within the supply chain at a same hierarchical level as the node to which the user corresponds, by referencing the database.
